(19) United States
(12) Patent Application Publication
(10) Pub. No.: US 2009/0319923 A1
(43) Pub. Date: Dec. 24, 2009

(54) METHOD FOR GENERATING ROLE-BASED USER INTERFACES UTILIZING UML MODELS

(75) Inventors: Rebecca Schaller, Hursley (GB); George C. Harley, Winchester (GB); Iain Duncan, Southampton (GB); Conor Beverland, Winchester (GB); Katharine Jagger, Winchester (GB); Diego Oriato, Hoddesdon (GB); Jay Limburn, Southampton (GB); Amanda E. Chessell, Alton (GB)

Correspondence Address: IBM CORPORATION (ACCSP);c/o Suiter Swantz pc llo, 14301 FNB Parkway, Suite 220, Omaha, NE, 68154, US

(73) Assignee: International Business Machines Corporation, Armonk, NY (US)

(21) Appl. No.: 12/143,171

(22) Filed: Jun. 20, 2008

(51) Int. Cl. G06F 3/048

(52) U.S. Cl. 715/762

(57) ABSTRACT

This disclosure proposes a set of rules for modeling that enable the generation of complete UI implementations at varying levels of abstraction. It also describes an engine that can interpret these rules and generate said UI. It differs from the prior art as it is not dependent on the raw data structure from the database but rather allows the concepts and objects a user interacts with to be modeled and mapped. It provides an additional level of sophistication allowing role-based customization and layout styles.

### TECHNICAL FIELD

The present disclosure generally relates to the field of business modeling and more particularly to a method for using a modeling language such as Unified Modeling Language (UML) to represent a business model.

### BACKGROUND

Many applications with a Graphical User Interface (GUI) allow the user to interact with an underlying business model. This invention describes a pattern and method whereby the graphical user interface can be generated by looking at a Unified Modeling Language (UML) representation of the model and interpreting the representation's structural and relationship meta-data.

The most widespread known solution for user interface creation is to program the user interfaces using a graphical user interface builder tool that allows controls to be placed onto a window in design mode, similar to the way a presentation or paint tool is used to create a drawing surface. When the user interface design is complete, the logic to read and write to the business model is programmed with custom logic. This is expensive, error prone, and requires specialized programming skills, as well as separate design skills to determine the layout and presentation of the user interface controls.

There are known solutions to improve on the manual solution of user interface creation to manipulate an underlying model. In the area of databases, prior art exists to describe how the database can be interrogated to create the user interface (U.S. Pat. No. 6,035,300, Method and apparatus for generating a user interface from the entity/attribute/relationship model of a database, incorporated herein by reference). This co-owned U.S. Pat. No. (6,035,300) teaches the creation of a working user interface by inspecting entities, attributes, and relationships of a database. The teachings of the '300 patent are exploited in tools such as IBM's VISUAL AGE™ products with the “quick form” capability, or products such as Microsoft's ACCESS™ form designer.

The drawback of the known solution is that the user interface does not interact directly with the database schema, but instead is operating with a higher level abstraction such as a business model described in UML. This drawback requires a technique that drives the user interface generation from the rules and semantics of the UML model.

### SUMMARY

UML is a much more complete representation of a business model than can be captured in a database schema. It operates at the level of objects and can describe relationships such as inheritance, cardinality that maybe optional, and bidirectional many-to-many relationship. Realizations of UML models can then enter into higher levels of abstraction describing users, tasks, roles, and commands and interactions that participants and actors may enjoy with the underlying model.

To facilitate the operation of an embodiment of the present invention, a pattern and method utilizing the semantics of meta-data rules (described in the UML model) may be utilized to create user interfaces at a varying degree of levels. The present invention utilizes UML interrogation (rather than prior art database schemas) to create a widget having the desired cardinality and base level.

At higher levels, information captured in the model (such as roles and tasks and actors) can be used to derive information from which a user interface can be generated. If the user is signed on with a particular role, or has input to the application that he or she is performing a certain role, then menu options should be altered, preferences for layout may be applied, and lists of entries refined to allow that user role to perform their task correctly. Certain roles might not have authority to access certain parts of the system; thus, buttons may be disabled, or when selected a user may be asked whether he or she wishes to switch roles. Additionally, security measures can be attached to the role to enforce governance of the system.

Because high level models such as UML are able to capture and model the semantics of the operations of the model, a sophisticated code generation engine can interrogate the model and generate the appropriate logic to enforce the high level rules contained in the model. This can either be code generation or else a runtime dynamically generated user interface so that as the model changes the user interface can always be current with the information it describes.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flow diagram of an embodiment of the present invention.

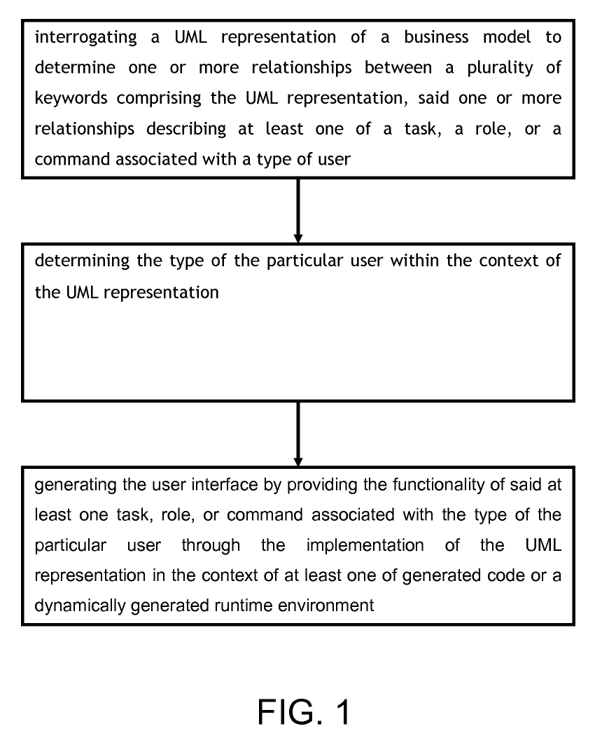

### DETAILED DESCRIPTION

Reference will now be made in detail to the subject matter disclosed, which is illustrated in the accompanying drawing.

In a preferred embodiment, at the most basic level, the code generation engine of the present invention, can interrogate the relationship keyword and cardinality described in the UML model and create user interface controls. The following table provides a list of some rules in an exemplary embodiment:

Parsimony UI Rendering table: (names in italics are used in orgmodel)

| | userObjectCardinality | Number of | Number of possible | |
|---|---|---|---|---|
| | of | UserObjectAttributes | values for the | |
| RelationshipType | TaskToUserObjectRel | on UserObject | UserObjectAttribute | Widget |
| <<select>> | 1 | 1 * | | Drop down list |
| | | | | Table/Radiobutton |
| <<select>> | * | 1 * | | selectMany |
| | | | | Table/checkbox |
| <<search>> | 1 | | Infinite * | Input Text (type: |
| | | | | dates, integer, etc) |
| | | | | Drop down list |
| <<create>> | 1 | (same as search) | | |
| <<update>> | 1 | (same as search) | | |
| <<delete>> | 1 * | (same as select) | | |
| <<view>> | 1 * | | | Table/Table |
| | | | | Table/Table |
| <<compare>> | 2 | | | Side by side table |
| | >2 | | | Separate tables |
| | | | | down the page |

The present method allows more information to be captured than is possible utilizing prior art methodologies. Additionally, the present invention utilization of UML to capture the semantic relationships between the entities allows more complex widgets and user interface controls to be created.

This allows for more of the model information to be utilized to generate the interface. For example, for UML models that capture organizational information, such as IBM's MASTER DATA MANAGEMENT™ (MDM), the additional information captured allows additional buttons and menu options to navigate the application. Likewise, controls that allow specific tasks to be performed may be created that require different users, roles and levels of authority, or the contents of lists and forms that vary depending on the role performed by a user.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. A method for generating a user interface having functionality specific to the role of a particular user, comprising:
interrogating a UML representation of a business model to determine one or more relationships between a plurality of keywords comprising the UML representation, said one or more relationships describing at least one of a task, a role, or a command associated with a type of user;
determining the type of the particular user within the context of the UML representation; and
generating the user interface by providing the functionality of said at least one task, role, or command associated with the type of the particular user through the implementation of the UML representation in the context of at least one of generated code or a dynamically generated runtime environment.
